(19) United States
(12) Patent Application Publication
(10) Pub. No.: US 2022/0369196 A1
(43) Pub. Date: Nov. 17, 2022

(54) CONTEXTUAL NETWORK FUNCTION SELECTION AND TRANSFER

(71) Applicant: AT&T Intellectual Property I, L.P., Atlanta, GA (US)

(72) Inventors: Rajendra Prasad Kodaypak, Sammamish, WA (US); Tjoen Kusardi, Sammamish, WA (US)

(21) Appl. No.: 17/320,432

(22) Filed: May 14, 2021

(51) Int. Cl. H04W 36/32; H04W 48/18; H04W 48/16; H04W 36/00; H04W 36/30

(52) U.S. Cl. CPC H04W 36/32; H04W 48/18; H04W 48/16; H04W 36/00835; H04W 36/30

(57) ABSTRACT

The described technology is generally directed towards contextual network function selection and transfer. Techniques disclosed herein can be implemented at core network access management functions (AMFs). An AMF can obtain user equipment context information via a gNodeB (gNB). Rather than causing a local default session management function (SMF) and user plane management function (UPF) to process user equipment communications, the AMF can use a mapping function to identify, based on the user equipment context information, a proximal SMF and corresponding UPF which have a nearer proximity to the user equipment. The AMF can facilitate selection of the proximal SMF and UPF for the user equipment, and the AMF can transfer the user equipment context information to a proximal AMF that is better situated to serve the proximal SMF and UPF. By facilitating transfer to the proximal SMF and UPF, communication latency experienced by the user equipment can be reduced.

### TECHNICAL FIELD

The subject application is related to fifth generation (5G), and subsequent generation cellular communication systems, e.g., to techniques to reduce the latency of network communications.

### BACKGROUND

In the 5G standalone radio access network architecture, gNodeB (gNB) cells are connected to access and mobility management functions (AMFs) using an N2 stream control transmission protocol (SCTP) based interface. These components exchange control plane signaling using the next generation application layer protocol (NG-AP).

gNB cells can be distributed within a geographic area and can be served by a single AMF, or multiple AMFs operating in a single or multi-regional pool environment. gNB cells can also serve legacy fourth generation (4G) long term evolution (LTE) traffic and thus attach to a fourth generation (4G) mobility management entity (MME).

A gNB serving 5G standalone user equipment can be connected to multiple AMFs within a regional AMF pool for operational resiliency. The AMFs within a pool region can serve, e.g., gNBs and the 5G standalone tracking areas (TAs) they belong to, according to an operator designed deployment topology. Because AMF capacity can be advertised uniformly by the AMFs in a pool, gNBs can attach to any AMF within that pool. These AMFs may have pairing with their LTE core counterpart MMEs to ensure seamless transitions between 5G and 4G radio access technologies.

Sub-optimal 5G control plane core network function selection within an AMF pool region is possible, and can impact AMF or MME pairing and interworking in a given pool region. Improper selection can furthermore lead to undesirable signaling, poor network performance and degraded end user service experiences.

The above-described background is merely intended to provide a contextual overview of some current issues, and is not intended to be exhaustive. Other contextual information may become further apparent upon review of the following detailed description.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an example wireless communication system, in accordance with various aspects and embodiments of the subject disclosure.

FIG. 2 illustrates example usage of AMFs in an AMF regional pool, in accordance with various aspects and embodiments of the subject disclosure.

FIG. 3 illustrates example regional pools including both AMFs and MMEs, and spanning multiple vendor regions, in accordance with various aspects and embodiments of the subject disclosure.

FIG. 4 illustrates example AMF selection of a session management function (SMF) and a corresponding user plane management function (UPF), in accordance with various aspects and embodiments of the subject disclosure.

FIG. 5 illustrates example AMF use of a mapping function to identify an SMF and corresponding UPF with nearer proximity to a user equipment (UE), in accordance with various aspects and embodiments of the subject disclosure.

FIG. 6 illustrates an example mapping function, in accordance with various aspects and embodiments of the subject disclosure.

FIG. 7 is a flow diagram representing example operations of core network equipment, in accordance with various aspects and embodiments of the subject disclosure.

FIG. 8 is a flow diagram representing another set of example operations of core network equipment, in accordance with various aspects and embodiments of the subject disclosure.

FIG. 9 is a flow diagram representing another set of example operations of core network equipment, in accordance with various aspects and embodiments of the subject disclosure.

FIG. 10 is a block diagram of an example computer that can be operable to execute processes and methods in accordance with various aspects and embodiments of the subject disclosure.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details, and without applying to any particular networked environment or standard.

One or more aspects of the technology described herein are generally directed towards contextual network function selection and transfer. In some examples, techniques disclosed herein can be implemented at core network AMFs. An AMF can obtain user equipment context information via a gNB. Rather than causing a local default session management function (SMF) and user plane management function (UPF) to process user equipment communications, the AMF can use a mapping function to identify, based on the user equipment context information, a proximal SMF and corresponding UPF which have a nearer proximity to the user equipment. The AMF can facilitate selection of the proximal SMF and UPF for the user equipment, and the AMF can also transfer the user equipment context information to a proximal AMF that is better situated to serve the proximal SMF and UPF. By facilitating transfer to the proximal SMF and UPF, communication latency experienced by the user equipment can be reduced.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “gNode B (gNB),” “evolved Node B (eNode B),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments have been described herein in the context of 4G, 5G, or other next generation networks, the disclosed aspects are not limited to a 4G or 5G implementation, and/or other network next generation implementations, as the techniques can also be applied, for example, in third generation (3G), or other 4G systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), single carrier FDMA (SC-FDMA), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), LTE frequency division duplex (FDD), time division duplex (TDD), 5G, third generation partnership project 2 (3GPP2), ultra mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology. In this regard, all or substantially all aspects disclosed herein can be exploited in legacy telecommunication technologies.

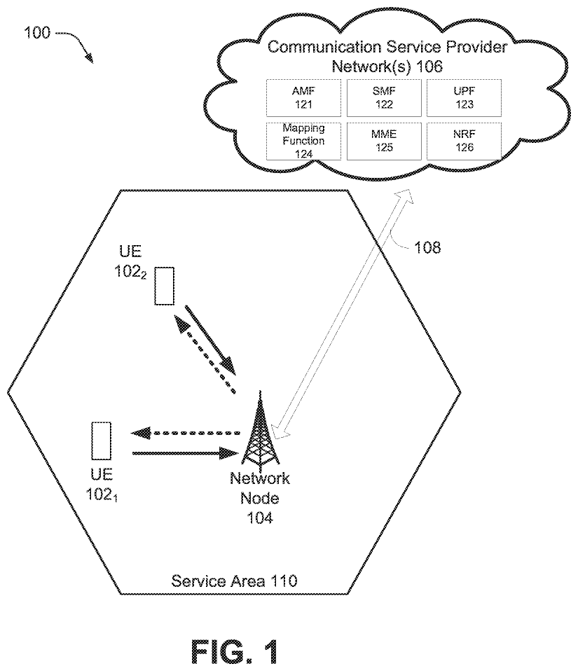

FIG. 1 illustrates a non-limiting example of a wireless communication system 100 which can be used in connection with at least some embodiments of the subject disclosure. In one or more embodiments, system 100 can comprise one or more user equipment UEs 1021, 1022, referred to collectively as UEs 102, a network node 104 that supports cellular communications in a service area 110, also known as a cell, and communication service provider network(s) 106.

The non-limiting term “user equipment” can refer to any type of device that can communicate with a network node 104 in a cellular or mobile communication system 100. UEs 102 can have one or more antenna panels having vertical and horizontal elements. Examples of UEs 102 comprise target devices, device to device (D2D) UEs, machine type UEs or UEs capable of machine to machine (M2M) communications, personal digital assistants (PDAs), tablets, mobile terminals, smart phones, laptop mounted equipment (LME), universal serial bus (USB) dongles enabled for mobile communications, computers having mobile capabilities, mobile devices such as cellular phones, laptops having laptop embedded equipment (LEE, such as a mobile broadband adapter), tablet computers having mobile broadband adapters, wearable devices, virtual reality (VR) devices, heads-up display (HUD) devices, smart cars, machine-type communication (MTC) devices, augmented reality head mounted displays, and the like. UEs 102 can also comprise IOT devices that communicate wirelessly.

In various embodiments, system 100 comprises communication service provider network(s) 106 serviced by one or more wireless communication network providers. Communication service provider network(s) 106 can comprise a “core network”. In example embodiments, UEs 102 can be communicatively coupled to the communication service provider network(s) 106 via network node 104. The network node 104 (e.g., network node device) can communicate with UEs 102, thus providing connectivity between the UEs 102 and the wider cellular network. The UEs 102 can send transmission type recommendation data to the network node 104. The transmission type recommendation data can comprise a recommendation to transmit data via a closed loop multiple input multiple output (MIMO) mode and/or a rank-1 precoder mode.

A network node 104 can have a cabinet and other protected enclosures, computing devices, an antenna mast, and multiple antennas for performing various transmission operations (e.g., MIMO operations) and for directing/steering signal beams. Network node 104 can comprise one or more base station devices which implement features of the network node 104. Network nodes can serve several cells, also called sectors or service areas, such as service area 110, depending on the configuration and type of antenna. In example embodiments, UEs 102 can send and/or receive communication data via a wireless link to the network node 104. The dashed arrow lines from the network node 104 to the UEs 102 can encode downlink (DL) communications to the UEs 102. The solid arrow lines from the UEs 102 to the network node 104 represent uplink (UL) communications.

Communication service provider network(s) 106 can facilitate providing wireless communication services to UEs 102 via the network node 104 and/or various additional network devices (not shown) included in the one or more communication service provider network(s) 106. The one or more communication service provider network(s) 106 can comprise various types of disparate networks, including but not limited to: cellular networks, femto networks, picocell networks, microcell networks, internet protocol (IP) networks Wi-Fi service networks, broadband service network, enterprise networks, cloud based networks, millimeter wave networks and the like. For example, in at least one implementation, system 100 can be or comprise a large scale wireless communication network that spans various geographic areas. According to this implementation, the one or more communication service provider network(s) 106 can be or comprise the wireless communication network and/or various additional devices and components of the wireless communication network (e.g., additional network devices and cell, additional UEs, network server devices, etc.).

Aspects of this disclosure relate to operations performed by certain components of communication service provider network(s) 106. These components include the AMF 121, SMF 122, UPF 123, MME 125, mapping function 124, and network repository function (NRF) 126. The mapping function 124 in particular is a novel aspect of this disclosure, and AMFs such as AMF 121 can be configured to use the mapping function 124 in connection with selection of SMFs such as SMF 122 and corresponding UPFs such as UPF 123 for use in connection with UEs 102. AMF 121 can be configured to use the mapping function 124 to ensure selection of a UPF that has a near proximity to a UE such as UE 1021, nearer than other UPFs of the communication service provider network(s) 106. The selection of a UPF having near proximity to a UE 1021 can reduce latency of network communications involving UE 1021.

The network node 104 can be connected to the one or more communication service provider networks 106 via one or more backhaul links 108. For example, the one or more backhaul links 108 can comprise wired link components, such as a T1/E1 phone line, a digital subscriber line (DSL) (e.g., either synchronous or asynchronous), an asymmetric DSL (ADSL), an optical fiber backbone, a coaxial cable, and the like. The one or more backhaul links 108 can also comprise wireless link components, such as but not limited to, line-of-sight (LOS) or non-LOS links which can comprise terrestrial air-interfaces or deep space links (e.g., satellite communication links for navigation). Backhaul links 108 can be implemented via a “transport network” in some embodiments. In another embodiment, network node 104 can be part of an integrated access and backhaul network. This may allow easier deployment of a dense network of self-backhauled 5G cells in a more integrated manner by building upon many of the control and data channels/procedures defined for providing access to UEs.

Wireless communication system 100 can employ various cellular systems, technologies, and modulation modes to facilitate wireless radio communications between devices (e.g., the UE 102 and the network node 104). While example embodiments might be described for 5G new radio (NR) systems, the embodiments can be applicable to any radio access technology (RAT) or multi-RAT system where the UE operates using multiple carriers, e.g., LTE FDD/TDD, GSM/GERAN, CDMA2000 etc.

For example, system 100 can operate in accordance with any 5G, next generation communication technology, or existing communication technologies, various examples of which are listed supra. In this regard, various features and functionalities of system 100 are applicable where the devices (e.g., the UEs 102 and the network device 104) of system 100 are configured to communicate wireless signals using one or more multi carrier modulation schemes, wherein data symbols can be transmitted simultaneously over multiple frequency subcarriers (e.g., OFDM, CP-OFDM, DFT-spread OFMD, UFMC, FMBC, etc.). The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, system 100 can be configured to provide and employ 5G or subsequent generation wireless networking features and functionalities. 5G wireless communication networks are expected to fulfill the demand of exponentially increasing data traffic and to allow people and machines to enjoy gigabit data rates with virtually zero (e.g., single digit millisecond) latency. Compared to 4G, 5G supports more diverse traffic scenarios. For example, in addition to the various types of data communication between conventional UEs (e.g., phones, smartphones, tablets, PCs, televisions, internet enabled televisions, AR/VR head mounted displays (HMDs), etc.) supported by 4G networks, 5G networks can be employed to support data communication between smart cars in association with driverless car environments, as well as machine type communications (MTCs). Considering the drastic different communication needs of these different traffic scenarios, the ability to dynamically configure waveform parameters based on traffic scenarios while retaining the benefits of multi carrier modulation schemes (e.g., OFDM and related schemes) can provide a significant contribution to the high speed/capacity and low latency demands of 5G networks. With waveforms that split the bandwidth into several sub-bands, different types of services can be accommodated in different sub-bands with the most suitable waveform and numerology, leading to an improved spectrum utilization for 5G networks.

To meet the demand for data centric applications, features of 5G networks can comprise: increased peak bit rate (e.g., 20 Gbps), larger data volume per unit area (e.g., high system spectral efficiency—for example about 3.5 times that of spectral efficiency of long term evolution (LTE) systems), high capacity that allows more device connectivity both concurrently and instantaneously, lower battery/power consumption (which reduces energy and consumption costs), better connectivity regardless of the geographic region in which a user is located, a larger numbers of devices, lower infrastructural development costs, and higher reliability of the communications. Thus, 5G networks can allow for: data rates of several tens of megabits per second should be supported for tens of thousands of users, 1 gigabit per second to be offered simultaneously to tens of workers on the same office floor, for example; several hundreds of thousands of simultaneous connections to be supported for massive sensor deployments; improved coverage, enhanced signaling efficiency; reduced latency compared to LTE.

The 5G access network can utilize higher frequencies (e.g., >6 GHz) to aid in increasing capacity. Currently, much of the millimeter wave (mmWave) spectrum, the band of spectrum between 30 GHz and 300 GHz is underutilized. The millimeter waves have shorter wavelengths that range from 10 millimeters to 1 millimeter, and these mmWave signals experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the 3GPP and has been in use (including with LTE), is a multi-antenna technique that can improve the spectral efficiency of transmissions, thereby significantly boosting the overall data carrying capacity of wireless systems. The use of MIMO techniques can improve mmWave communications and has been widely recognized as a potentially important component for access networks operating in higher frequencies. MIMO can be used for achieving diversity gain, spatial multiplexing gain and beamforming gain. For these reasons, MIMO systems are an important part of the 3rd and 4th generation wireless systems and are in use in 5G systems.

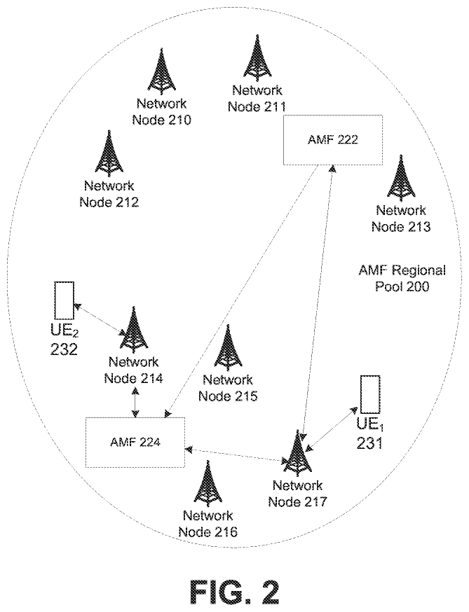

FIG. 2 illustrates example usage of AMFs in an AMF regional pool, in accordance with various aspects and embodiments of the subject disclosure. FIG. 2 includes an example AMF regional pool 200 that provides AMFs, including AMF 222 and AMF 224, for use by network nodes in a geographical area, including network nodes 210, 211, 212, 213, 214, 215, 216, and 217. FIG. 2 illustrates a UE₁ 231 and a UE₂ 232. UE₂ 232 connects to network node 214 and UE₂ 232 is served by AMF 224. UE₁ 231 connects to network node 217 and UE₁ 231 is initially served by AMF 222. Application of techniques described herein can result in, inter alia, transfer of UE₁ 231 from AMF 222 to AMF 224

The geographical area served by AMF regional pool 200 can be large, and some AMFs in the AMF regional pool 200 can be nearer to one or more of network nodes 210-217 than other AMFs in the AMF regional pool 200. For example, AMF 222 is nearer to network nodes 210-213, while AMF 224 is nearer to network nodes 214-217. Despite the different proximities of AMFs 222, 224 to different ones of network nodes 210-217, the inclusion of AMFs 222, 224 in the AMF regional pool 200 can potentially lead to selection of an AMF, such as AMF 222 for use in connection with a UE₁ 231 which is a large distance away from AMF₁ 222, even though a nearer proximity AMF, namely AMF 224, is included in the AMF regional pool 200. Embodiments of this disclosure can correctively transition the UE₁ 231 to the nearer proximity AMF 224.

Furthermore, AMFs 222, 224 can be configured to select other network elements, e.g., SMFs and UPFs (not shown in FIG. 2) to serve UEs 231, 232. If AMFs 222, 224 are configured to select nearby SMFs and UPFs by default, which are nearby the AMFs 222, 224, respectively, then when UE₁ 231 is served by a far-away AMF 222, the UE₁ 231 may also be served by a far-away SMF and UPF. Embodiments of this disclosure allow AMF 222 to instead identify and select an SMF and UPF that have a nearer proximity to UE₁ 231. A selected SMF and UPF can be nearer to UE₁ 231 than, e.g., AMF 222 as well as an SMF and UPF which are proximal to the AMF 222. AMF 222 can facilitate establishing a session including an SMF and UPF which are nearer to the AMF 224, and AMF 222 can optionally then transfer its own service of UE₁ 231 to the more proximal AMF 224.

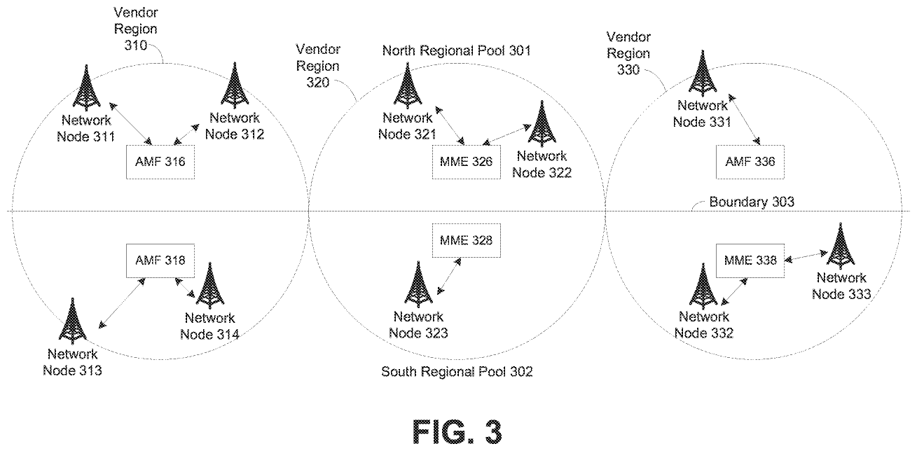

FIG. 3 illustrates example regional pools including both AMFs and MMEs, and spanning multiple vendor regions, in accordance with various aspects and embodiments of the subject disclosure. FIG. 3 includes a north regional pool 301 and a south regional pool 302 separated by a boundary 303. Vendor region 310, vendor region 320 and vendor region 330 are each designated by a dashed circle. Each vendor region 310, 320, 330 is a region wherein a different equipment vendor supplies network nodes. In the vendor region 310, a first vendor supplies network nodes 311, 312, 313, and 314. In the vendor region 320, a second vendor supplies network nodes 321, 322, and 323. In the vendor region 330, a third vendor supplies network nodes 331, 332, and 333. Thus each vendor supplies some network nodes in the north regional pool 310, and some network nodes in the south regional pool 302.

The north regional pool 301 can include both AMFs and MMEs, e.g., AMF 316, MME 326, and AMF 336. Similarly, the south regional pool 302 can include both AMFs and MMEs, e.g., AMF 318, MME 328, and MME 338. FIG. 3 provides a demonstration of real world conditions into which solutions according to this disclosure can be deployed. Embodiments of this disclosure can be configured to accommodate AMFs in different regions provided by multiple different vendors, as well as legacy MMEs that serve some network nodes.

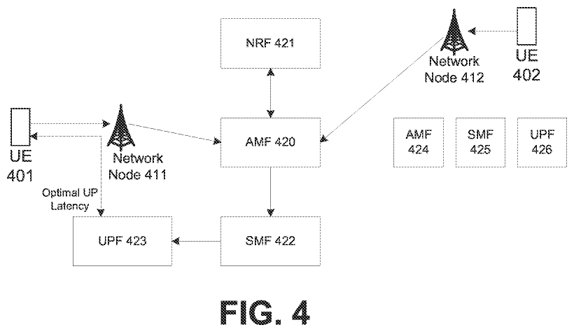

FIG. 4 illustrates example AMF selection of a session management function (SMF) and a corresponding user plane management function (UPF), in accordance with various aspects and embodiments of the subject disclosure. FIG. 4 includes a UE 401, a network node 411, a UE 402 and a network node 412. Furthermore, FIG. 4 includes various core network elements, including an AMF 420, an NRF 421, an SMF 422, and a UPF 423, wherein the network elements 420-423 are nearby the network node 411. Additional core network elements including AMF 424, SMF 425, and UPF 426 are nearby the network node 412.

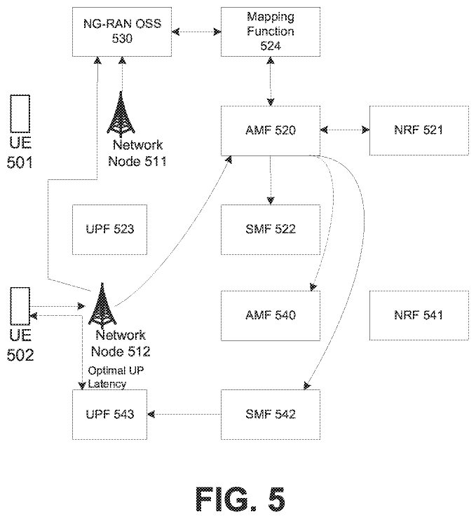

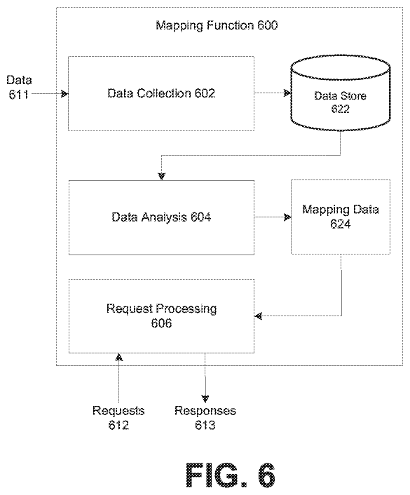

FIG. 4 illustrates a network condition that can trigger a use of a mapping function according to this disclosure. The mapping function is further described in connection with FIG. 5 and FIG. 6. First, a discussion of network operations on behalf of UE 401 is set forth below, followed by a discussion of UE 402 and corresponding benefits of a mapping function such as described herein.

The UE 401 can connect to network node 411, which can optionally connect to an appropriate AMF 420, wherein the appropriate AMF 420 is generally nearby the network node 411. The AMF 420 can query NRF 421 to identify an SMF 422 for use in connection with UE 401 communications. The AMF 420 can facilitate establishing a session at SMF 422 for the UE 401. The SMF 422 can engage UPF 423 on behalf of the UE 401. Under some network conditions, an appropriate AMF 420 can lead to selection of an appropriate SMF 422 and an appropriate UPF 423, wherein the UPF 423 is near the network node 411 and the UPF 423 provides optimal user plane (UP) latency in connection with UE 401.

However, under some other network conditions, it is possible that a network node, such as network node 412, may connect to a less appropriate AMF on behalf of a UE, such as UE 402. For example, the network node 412 may connect the UE 402 with the AMF 420, instead of a nearby AMF 424. Without the use of a mapping function such as described herein, the AMF 420 can repeat the operations described above with reference to UE 401, resulting in a use of UPF 423 for UE 402. Such an outcome would not produce optimal UP latency for UE 402.

The use of a mapping function, described further in connection with FIG. 5, can allow the AMF 420 to identify and select SMF 425 on behalf of UE 402, while identifying and selecting SMF 422 on behalf of UE 401, as described above. The SMF 425 can engage UPF 426 on behalf of UE 402, resulting in improved, and potentially optimal UP latency for UE 402.

FIG. 5 illustrates example AMF use of a mapping function to identify an SMF and corresponding UPF with nearer proximity to a UE, in accordance with various aspects and embodiments of the subject disclosure. FIG. 5 includes a UE 501, a network node 511, a UE 502, and a network node 512. Furthermore, core network elements that are generally more proximal to the network node 511 include AMF 520, NRF 521, SMF 522, and UPF 523. Core network elements that are generally more proximal to the network node 512 include AMF 540, NRF 541, SMF 542, and UPF 543. FIG. 5 furthermore illustrates a next generation radio access network operations support system (NG-RAN OSS) 530, and a mapping function 524.

The scenario illustrated in FIG. 5 is generally similar to the scenario introduced in FIG. 4, wherein UE 502 is analogous to UE 402, network node 512 is analogous to network node 412, AMF 520 is analogous to AMF 420, and AMF 540 is analogous to AMF 424. AMF 520 can be configured to consult the mapping function 524 in order to identify the SMF 542, wherein the SMF 542 is at nearer proximity to network node 512 and/or UE 502 than other network equipment, such as SMF 522 and UPF 523. AMF 520 can be configured to facilitate a session at SMF 542 on behalf of UE 502. The SMF 542 can engage UPF 543, which can provide improved and potentially optimal UP latency in connection with UE 502 communications. In addition, the AMF 520 can optionally transfer context information pertaining to UE 502 to the AMF 540 which is associated with SMF 542.

In some embodiments, the mapping function 524 can operate in part by collecting UE context information. For example, NG-RAN OSS 530 can collect UE context information, including UE 502 context information as well as UE 501 context information. The NG-RAN OSS 530 can collect the UE context information from network nodes 512, 511. The NG-RAN OSS 530 can optionally be configured to provide UE context information to the mapping function 524, which enables the mapping function 524 improve its operation through machine learning.

The AMF 520 can also obtain UE context information in connection with service provided to UE 502. The AMF 520 can optionally be configured to use UE 502 context information in connection with using the mapping function 524 to identify an SMF 542 for UE 502.

In some embodiments, the mapping function 524 can be implemented as an independent core network function. In other embodiments, the mapping function 524 can be implemented at least partially within each of the AMFs 520, 540. Those of skill in the relevant art will appreciate that numerous architectural arrangements are feasible.

In an example according to FIG. 5, network node 511 can be located in, e.g., Atlanta, while network node 512 can be located in, e.g., Washington, D.C. UE 502 initially camps in the Washington, D.C. tracking area code (TAC) but selects the Atlanta AMF 520 due to randomized AMF selection procedures in the RAN. The AMF 520 discovers the Washington, D.C. location of UE 502 from UE 502's initial registration request, which can include, e.g., an NR Cell ID and 5G TAC associated with network node 512. The AMF 520 can query the NRF 521 to discover registered SMFs allowed for UE 502's TAC and/or TAC range. The AMF 520 can use the mapping function 524 to select the Washington, D.C. SMF 542. A mapping function 524 analysis can identify a geo-optimized SMF selection, which in this example identifies SMF 542. The Washington, D.C. SMF 542 selects the Washington, D.C. UPF 543, as SMF 542 gets the UE 502 location information (ULI) via its protocol data unit (PDU) session establishment request. Finally, the Atlanta AMF 520 can move the UE 520 context to the Washington, D.C. AMF 540 for any subsequent signaling upon completion of the initial PDU session establishment procedure.

In general, with regard to FIG. 5, the cellular communications industry is moving towards development and commercialization of standards-based centralized radio access network (CRAN)/open radio access network (ORAN) solutions. The complexity of ORAN implementations adds to the inter-operability at the protocol application layer and in turn impacts overall control plane network functions selection as well as end user service performance. In the 5G standalone radio access network, the NG-RAN/gNB cells at network nodes 511, 512 can be connected using the N2 stream control transmission protocol (SCTP) based interface towards the AMFs 520, 540. The gNB cells exchange signaling using the NG-AP application layer protocol. These cells can be distributed within a geographic area and can be served by a single AMF or multiple AMFs operating in a single or multi-regional pool environment. These cells can also serve legacy LTE traffic and thus attach to an MME, e.g., during transition between 4G and 5G technologies.

In an aspect, this disclosure can provide an intelligent control plane end user/device contextual transfer based on dynamic learning, by mapping function 524, of a variety of data. Such data can include, e.g., AMF 5G TAC to global gNB identifier (ID) mappings, MME LTE TAC to global eNodeB ID (eNBID) mappings, respective capacities of AMFs and MMEs, and mobility patterns of the UEs 501, 502. The mapping function 542 can thereby enhance control plane network function selection for UEs 501, 502 within a geographical area and during mobility across the geographical regions served by different AMF-MME pool regions. AMF-MME contextual user analytics mapping, in conjunction with serving 4G/5G elements via their cell IDs and TACs, can be tracked continually by the mapping function 542 to monitor, measure and reroute UEs, such as UE 502, to their closest SMF 542 as well as UPF 543.

In a split regional model example, the gNBs within a north-south boundary could be served by an AMF pool comprising a north-south AMF network function with N+1 (N=2) redundancy for resilient operation. A serving gNB in the north could be connected to north-south AMFs and potentially a third AMF that could be located within the same pool region. The AMF pool region may have a unique paired MME pool region, or multiple AMF pool regions may align with a single MME pool region.

The gNBs can be configured with N2 interface internet protocol (IP) addresses of the AMFs in their pool region, so that they can set up their SCTP associations with the AMFs. They can exchange 5G tracking area information during the 5G setup process, so that the AMF can learn and update it internally in its 5G tracking area list. While the AMF can register AMF profile information initially with the NRF, dynamic changes in the 5G tracking area information may not get updated in real time, leaving insufficient time for NRFs to advertise such changes to peer network functions. The AMFs in a pool region can advertise their relative capacity to the gNBs as part of the 5G setup procedures. These can be set to an identical value to allow the gNBs to load balance across the AMF pool region, but such information can be dynamically changed based on an internal mapping table with analytics driven capabilities.

For a user located in the south region, their south gNB may try to select the AMF in the north region, as shown in FIG. 5, due to randomization of the N2 selection algorithm. Any transport/link layer issues can result in retransmissions and longer latencies during the 5G standalone registration procedures and this can potentially be fatal to signaling requirements associated with ultra-reliable low latency applications including augmented reality/virtual reality (AR/VR), autonomous driving, etc. Lack of intelligent mapping between the gNB identifiers (IDs), tracking areas (TAs) and relative capacities advertised by the AMFs can result in inordinate signaling delays. The mapping function 524 can be configured to take into account LTE overlay/underlay and its TAC information along with the serving MMEs to ensure there is a composite mapping for 4G and 5G technologies to deliver superior mobility interworking and customer experience.

In an embodiment, the mapping function 524 can be implemented in an NG signaling controller, and can work across both 5G and 4G systems. The mapping function 524 can be configured to dynamically learn gNBID and 5G tracking area information from collected UE contextual data, and the mapping function 524 can utilize its peer AMF instance IDs along with their relative capacities and latencies towards each of them to perform AMF redirection to a peer that is closer or closest within the AMF pool region. Such contextual learning and mapping methods benefit the next-generation mobility users/devices with their signaling setup that is access dependent, which in turn enhances the overall element selection in a manner that can help to meet service assurance for ultra-low latency applications.

In an embodiment, FIG. 5 can be understood as an example of a north-south AMF pool region. The UE 502 served by the NR Cell (gNB) 512 within the south TAC can establish an N2 link with both AMF 520 and AMF 540. Meanwhile, the UE 501 served by the NR Cell (gNB) 511 with the north TAC can establish an N2 link with both AMF 520 and AMF 540. Due to random selection of the AMFs by gNBs 511, 512, the UE 502 can land on the AMF 520 instead of AMF 540. AMF 520 is registered to NRF 521 and can register the UE 502 in the network.

The introduction of a mapping function 524 enables the AMF 520 to continually evaluate UE contextual information. In some embodiments, the mapping function 524 can be configured as an intelligent context transfer activate request (CTAR) mapping function. The mapping function 524 can be aware of NG-RAN current cell level information via the NG-RAN OSS 530 using an open standards interface/REST API. Based on cell ID, TAC, AMF primary serving node, AMF peer serving nodes, and/or relative capacity, the mapping function 524 can perform mapping analytics to intelligently select the SMF 542 for the UE 502 data connection.

In some embodiments, the mapping function 524 can be configured to use a default data network name (DNN) which in turn can establish an N4 packet forwarding control protocol (PFCP) association with the UPF 543. Upon successful establishment of an initial PDU session using the DNN, the AMF 520 can internally reroute the UE 502 context to its peer AMF 540 as an automated seamless subscriber move operation for subsequent signaling establishment procedures.

By avoiding the standards defined NG-AP layer rerouting method that is signaling intensive and adds additional delays, direct AMF peer routing within an AMF north-south pool region across multiple data centers can simplify network function selection in a 5G network. A mapping function 524 thereby supports delivery of service requirements of enhanced mobile broadband, ultra-reliable low latency communication, edge computing, massive mission critical IoT and cellular vehicle-to-everything use cases over a 5G network infrastructure.

In some embodiments, the mapping function 524 can be extended to meet the needs of complex 5G to 4G interworking for end users and/or devices as they move between 5G and 4G, or Wi-Fi/WiFi6 domains in a mature network evolution model. Since an AMF terminates a non-3GPP access network from a non-access stratum (NAS) layer perspective, the next-generation signaling controller (AMF-MME) can act as a unified control plane gateway function for both 3GPP and non-3GPP accesses. Embodiments can rely on the mapping function 524 to include the MME, its associated LTE Cell ID, LTE TAC, MME serving node, MME peer node, and/or MME relative capacity, to be able to make multi-mode 5G, 4G, and/or Wi Fi UE contextual rerouting based on a variety of systemic attributes such as device types, registration modes, RF coverage area, access type, and priority/capacity/load/utilization levels, to improve network functions selection in a given technology.

FIG. 6 illustrates an example mapping function, in accordance with various aspects and embodiments of the subject disclosure. The example mapping function 600 can implement, e.g., the mapping function 524 introduced in FIG. 5. The mapping function 600 includes data collection 602, data store 622, data analysis 604, mapping data 624, and request processing 606. In general, data collection 602 can collect data 611, wherein data 611 can include any of the data described herein, and with reference to FIG. 5 in particular, in connection with mapping functions. Data collection 602 can store the data 611 in the data store 622.

Data analysis 604 can optionally process the data 611 stored in the data store 624 to generate mapping data 624. Mapping data 624 can comprise an organized form of data in data store 622, to facilitate identification of a proximal SMF or UPF for a UE, give the UE location, the UE mobility pattern, the network node serving the UE, the UE TAC, or other UE context information. In some embodiments, data analysis 604 can comprise a machine learning model that identifies SMFs or UPFs for UEs which minimize the UE's UP latency measurements.

Request processing 606 can be configured to receive incoming requests 612 and provide responses 613 in response thereto. Requests 612 can comprise, e.g., requests from AMFs that request identifications of proximal SMFs or UPFs for UEs, given known UE context information. Request processing 606 can use data in data store 622 and/or mapping data 624 to process requests 612 and thereby generate responses 613. Responses 613 can comprise SMF or UPF identifications which identify proximal SMFs or UPFs for UEs identified in the requests 612. FIG. 6 provides one example arrangement of components for a mapping function 600, and it will be appreciated that numerous other arrangements can be made within the spirit and scope of the teachings herein.

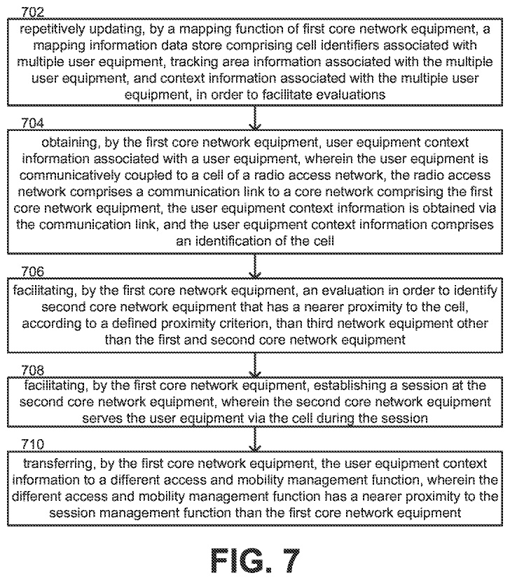

FIG. 7 is a flow diagram representing example operations of core network equipment, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

The operations illustrated in FIG. 7 can be performed, for example, by first core network equipment comprising a network element such as AMF 520, illustrated in FIG. 5. The AMF 520 can comprise, or otherwise access, a mapping function 524. Example operation 702 comprises repetitively updating, by a mapping function (524) of first core network equipment (AMF 520), a mapping information data store (data store 622) comprising cell identifiers (of network nodes 511, 512) associated with multiple user equipment (UE 501, UE 502, and others), tracking area information associated with the multiple user equipment (UE 501, UE 502, and others), and context information associated with the multiple user equipment (UE 501, UE 502, and others), in order to facilitate evaluations.

Example operation 704 comprises obtaining, by first core network equipment (AMF 520), user equipment context information associated with a user equipment (UE 502), wherein the user equipment (UE 502) is communicatively coupled to a cell of a radio access network (network node 512), the radio access network comprises a communication link (link 108 in FIG. 1) to a core network comprising the first core network equipment (AMF 520), the user equipment context information is obtained via the communication link (link 108), and the user equipment context information comprises an identification of the cell (at network node 512).

Example operation 706 comprises facilitating, by the first core network equipment (AMF 520), an evaluation (e.g., an evaluation by mapping function 524) in order to identify second core network equipment (SMF 542) that has a nearer proximity to the cell (network node 512), according to a defined proximity criterion, than third network equipment (SMF 522 and/or UPF 523) other than the first and second core network equipment (AMF 520 and SMF 542). The defined proximity criterion can comprise, e.g., a geographical distance or a “network distance” comprising a measurement of network element proximity in terms of network travel time.

In an example, the user equipment context information obtained at operation 704 can comprise user equipment (UE 502) location information, and operation 706 can comprise facilitating, by the first core network equipment (AMF 520), application of the user equipment context information in connection with identifying the second core network equipment (SMF 542).

In some embodiments, facilitating the evaluation in order to identify the second core network equipment (SMF 542) at operation 706 can comprise querying, by the first core network equipment (AMF 520), a network repository function (NRF 521), in order to obtain a group of session management functions associated with a tracking area applicable to the user equipment (UE 502), and selecting, by the first core network equipment (AMF 520), based on the user equipment context information and locations of session management functions in the group of session management functions, a session management function (SMF 542) from the group of session management functions, wherein the second core network equipment comprises the session management function (SMF 542). Selecting the session management function (SMF 542) can be further based on respective capacities of the session management functions in the group of session management functions.

In some embodiments, operation 706 can comprise facilitating, by the first core network equipment (AMF 520), using a mobility pattern associated with the user equipment (UE 502) in connection with identifying the second core network equipment (SMF 542). For example, mapping function 524 can be configured to collect mobility patterns associated with multiple different UEs. The mapping function 524 can use collected mobility patterns, along with UE 502 context information, to identify a likely mobility pattern associated with UE 502. The identification of SMF 542 by mapping function 524 can be based in part on the likely future movement (mobility pattern) of UE 502.

In some embodiments, operation 706 can comprise a first evaluation of core network equipment associated with a first network communication protocol (such as an evaluation of SMFs associated with the 5G network communication protocol) and a second evaluation of core network equipment associated with a second network communication protocol (such as an evaluation of SMFs associated with the 4G network communication protocol).

Example operation 708 comprises facilitating, by the first core network equipment (AMF 520), establishing a session at the second core network equipment (SMF 542), wherein the second core network equipment (SMF 542) serves the user equipment (UE 502) via the cell (network node 512) during the session. The session management function (SMF 542) can be configured to select a user plane management function (UPF 543) for use during the session. Example operation 710 comprises transferring, by the first core network equipment (AMF 520), the user equipment context information to a different access and mobility management function (AMF 540), wherein the different access and mobility management function (AMF 540) has a nearer proximity to the session management function (SMF 542) than the first core network equipment (AMF 520).

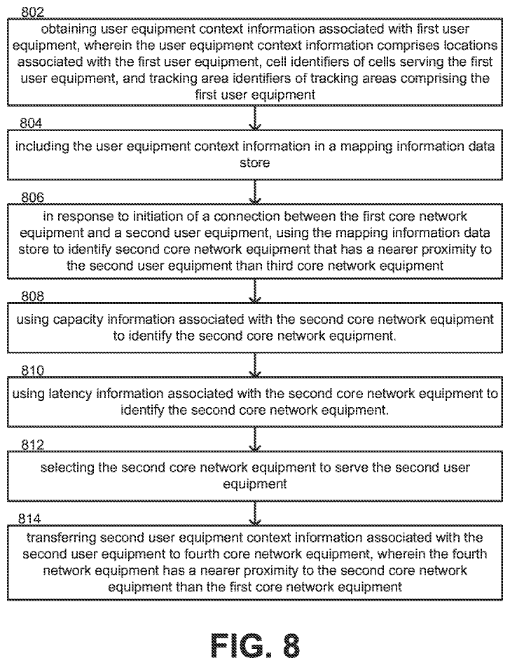

FIG. 8 is a flow diagram representing another set of example operations of core network equipment, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

The operations illustrated in FIG. 8 can be performed, for example, by first core network equipment such as equipment comprising the AMF 520 illustrated in FIG. 5. The AMF 520 can comprise, or otherwise access, a mapping function 524. The first core network equipment (AMF 520) can be included in a geographically distributed pool of network equipment (similar to AMF regional pool 200) that serves a cell (network node 512) that is communicatively coupled with second user equipment (UE 502). Example operation 802 comprises obtaining user equipment context information associated with first user equipment (such as UE 501 and others), wherein the user equipment context information comprises locations associated with the first user equipment (UE 501 and others), cell identifiers of cells (such as network node 511) serving the first user equipment (UE 501 and others), and tracking area identifiers of tracking areas comprising the first user equipment (UE 501 and others).

Example operation 804 comprises including the user equipment context information in a mapping information data store (data store 622 in FIG. 6). A variety of other data can be stored in data store 622, e.g., network element to network node mapping information, UE mobility patterns, capacity information associated with various network elements, and other information as described in connection with FIG. 5.

Example operation 806 comprises, in response to initiation of a connection between the first core network equipment (AMF 520) and a second user equipment (UE 502), using the mapping information data store (data store 622 in FIG. 6) to identify second core network equipment (SMF 542) that has a nearer proximity to the second user equipment (UE 502) than third core network equipment (such as SMF 522).

Example operations 808 and 810 provide some example further operations that can be used to improve SMF identification pursuant to operation 806. Example operation 808 comprises using capacity information associated with the second core network equipment (SMF 542) to identify the second core network equipment (SMF 542). Example operation 810 comprises using latency information associated with the second core network equipment (SMF 542) to identify the second core network equipment (SMF 542). Further operations can be used to take into account any of the data that can be used by the mapping function 524, as described further in connection with FIG. 5. Example operation 812 comprises selecting the second core network equipment (SMF 542) to serve the second user equipment (UE 502).

Example operation 814 comprises transferring second user equipment context information associated with the second user equipment (UE 502) to fourth core network equipment (AMF 540), wherein the fourth network equipment (AMF 540) has a nearer proximity to the second core network equipment (SMF 542) than the first core network equipment (AMF 520).

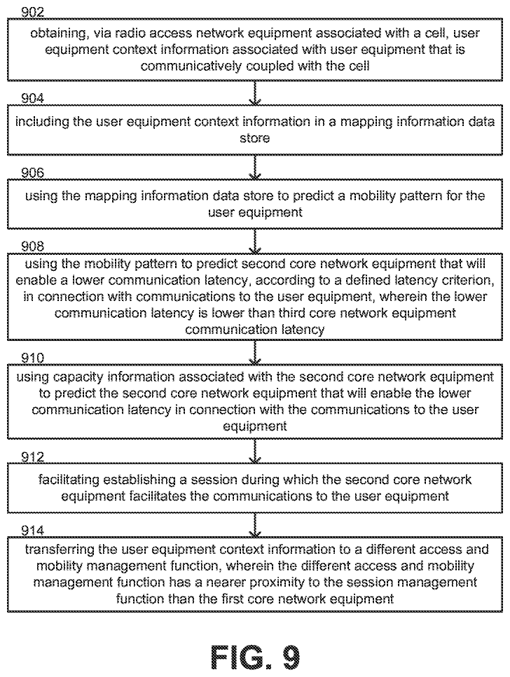

FIG. 9 is a flow diagram representing another set of example operations of core network equipment, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

The operations illustrated in FIG. 9 can be performed, for example, by first core network equipment such as equipment comprising AMF 520 illustrated in FIG. 5. The AMF 520 can comprise, or otherwise access, a mapping function 524. Example operation 902 comprises obtaining, via radio access network equipment (network node 512) associated with a cell, user equipment context information associated with user equipment (UE 502) that is communicatively coupled with the cell.

Example operation 904 comprises including the user equipment context information in a mapping information data store (data store 622). Example operation 906 comprises using the mapping information data store (data store 622) to predict a mobility pattern for the user equipment (UE 502). Example operation 908 comprises using the mobility pattern to predict second core network equipment (SMF 542) that will enable a lower communication latency, according to a defined latency criterion, in connection with communications to the user equipment (UE 502), wherein the lower communication latency is lower than third core network equipment (SMF 522) communication latency. The defined latency criterion can comprise, e.g., actual or predicted latencies associated with communications of SMFs via the network node 512 to which the UE 502 is connected.

Example operation 910 comprises using capacity information associated with the second core network equipment (SMF 542) to predict the second core network equipment (SMF 542) that will enable the lower communication latency in connection with the communications to the user equipment (UE 502). Operation 910 provides one example of additional information (capacity information) which can be used in connection with identifying a more appropriate or most/optimally appropriate network element, such as SMF 542.

Example operation 912 comprises facilitating establishing a session during which the second core network equipment (SMF 542) facilitates the communications to the user equipment (UE 502). For example, AMF 520 can select or otherwise initiate a session at SMF 542. Example operation 914 comprises transferring the user equipment context information to a different access and mobility management function (AMF 540), wherein the different access and mobility management function (AMF 540) has a nearer proximity to the session management function (SMF 542) than the first core network equipment (AMF 520).

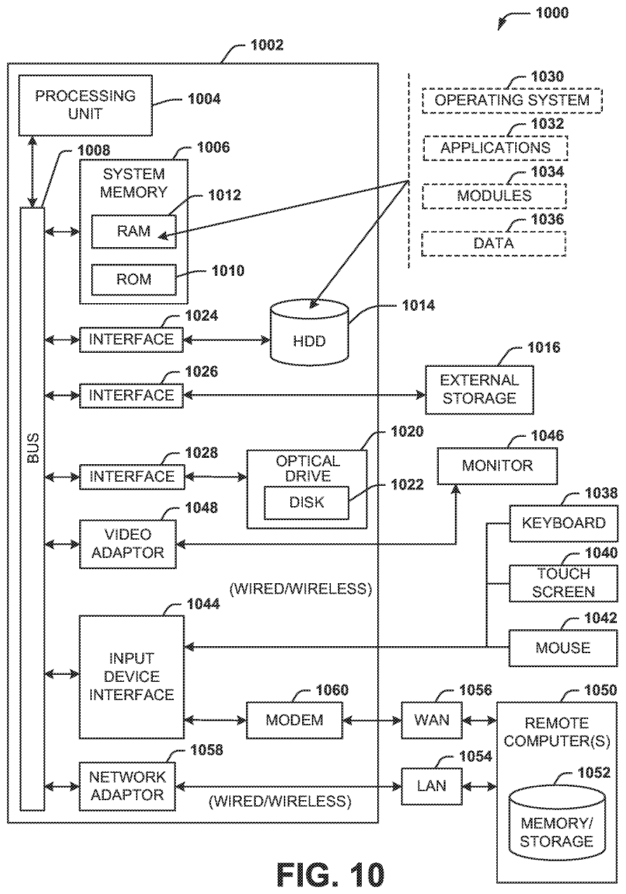

FIG. 10 is a block diagram of an example computer that can be operable to execute processes and methods in accordance with various aspects and embodiments of the subject disclosure. The example computer can be adapted to implement, for example, any of the various network equipment described herein.

FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), smart card, flash memory (e.g., card, stick, key drive) or other memory technology, compact disk (CD), compact disk read only memory (CD-ROM), digital versatile disk (DVD), Blu-ray™ disc (BD) or other optical disk storage, floppy disk storage, hard disk storage, magnetic cassettes, magnetic strip(s), magnetic tape, magnetic disk storage or other magnetic storage devices, solid state drives or other solid state storage devices, a virtual device that emulates a storage device (e.g., any storage device listed herein), or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
obtaining, by first core network equipment comprising a processor, user equipment context information associated with a user equipment, wherein:
the user equipment is communicatively coupled to a cell of a radio access network,
the radio access network comprises a communication link to a core network comprising the first core network equipment,
the user equipment context information is obtained via the communication link, and
the user equipment context information comprises an identification of the cell;
facilitating, by the first core network equipment, an evaluation in order to identify second core network equipment that has a nearer proximity to the cell, according to a defined proximity criterion, than third network equipment other than the first and second core network equipment; and
facilitating, by the first core network equipment, establishing a session at the second core network equipment, wherein the second core network equipment serves the user equipment via the cell during the session.

2. The method of claim 1, wherein the first core network equipment comprises an access and mobility management function, wherein the second core network equipment comprises a session management function, and wherein the third core network equipment comprises other session management functions other than the session management function.

3. The method of claim 2, wherein the session management function is configured to select a user plane management function for use during the session.

4. The method of claim 2, further comprising transferring, by the first core network equipment, the user equipment context information to a different access and mobility management function, wherein the different access and mobility management function has a nearer proximity to the session management function than the first core network equipment.

5. The method of claim 1, wherein facilitating the evaluation in order to identify the second core network equipment comprises:
querying, by the first core network equipment, a network repository function, in order to obtain a group of session management functions associated with a tracking area applicable to the user equipment; and
selecting, by the first core network equipment, based on the user equipment context information and locations of session management functions in the group of session management functions, a session management function from the group of session management functions, wherein the second core network equipment comprises the session management function.

6. The method of claim 5, wherein selecting the session management function is further based on respective capacities of the session management functions in the group of session management functions.

7. The method of claim 1, wherein the evaluation uses a mobility pattern associated with the user equipment in connection with identifying the second core network equipment.

8. The method of claim 1, wherein the user equipment context information comprises user equipment location information, and wherein the evaluation uses the user equipment context information in connection with identifying the second core network equipment.

9. The method of claim 1, further comprising repetitively updating, by a mapping function of the first core network equipment, a mapping information data store comprising cell identifiers associated with multiple user equipment, tracking area information associated with the multiple user equipment, and context information associated with the multiple user equipment, in order to facilitate evaluations comprising the evaluation.

10. The method of claim 1, wherein the evaluation comprises a first evaluation of core network equipment associated with a first network communication protocol and a second evaluation of core network equipment associated with a second network communication protocol.

11. First core network equipment, comprising:
a processor; and
a memory that stores executable instructions that, when executed by the processor, facilitate performance of operations, comprising:
obtaining user equipment context information associated with first user equipment, wherein the user equipment context information comprises locations associated with the first user equipment, cell identifiers of cells serving the first user equipment, and tracking area identifiers of tracking areas comprising the first user equipment;
including the user equipment context information in a mapping information data store;
in response to initiation of a connection between the first core network equipment and a second user equipment, using the mapping information data store to identify second core network equipment that has a nearer proximity to the second user equipment than third core network equipment; and
selecting the second core network equipment to serve the second user equipment.

12. The first core network equipment of claim 11, wherein the first core network equipment is included in a geographically distributed pool of network equipment that serves a cell that is communicatively coupled with the second user equipment.

13. The first core network equipment of claim 11, wherein the operations further comprise using capacity information associated with the second core network equipment to identify the second core network equipment.

14. The first core network equipment of claim 11, wherein the operations further comprise using latency information associated with the second core network equipment to identify the second core network equipment.

15. The first core network equipment of claim 11, wherein the first core network equipment comprises an access and mobility management function, wherein the second core network equipment comprises a session management function, and wherein the third core network equipment comprises session management functions other than the session management function.

16. The first core network equipment of claim 11, wherein the user equipment context information is first user equipment context information, wherein the operations further comprise transferring second user equipment context information associated with the second user equipment to fourth core network equipment, and wherein the fourth network equipment has a nearer proximity to the second core network equipment than the first core network equipment.

17. A non-transitory machine-readable medium, comprising executable instructions that, when executed by a processor of first core network equipment, facilitate performance of operations, comprising:
obtaining, via radio access network equipment associated with a cell, user equipment context information associated with user equipment that is communicatively coupled with the cell;
including the user equipment context information in a mapping information data store;
using the mapping information data store to predict a mobility pattern for the user equipment;
using the mobility pattern to predict second core network equipment that will enable a lower communication latency, according to a defined latency criterion, in connection with communications to the user equipment, wherein the lower communication latency is lower than third core network equipment communication latency; and
facilitating establishing a session during which the second core network equipment facilitates the communications to the user equipment.

18. The non-transitory machine-readable medium of claim 17, wherein the first core network equipment comprises an access and mobility management function, wherein the second core network equipment comprises a session management function, and wherein the session management function is configured to select a user plane management function for use during the session.

19. The non-transitory machine-readable medium of claim 18, wherein the operations further comprise transferring the user equipment context information to a different access and mobility management function, wherein the different access and mobility management function has a nearer proximity to the session management function than the first core network equipment.

20. The non-transitory machine-readable medium of claim 17, wherein the operations further comprise using capacity information associated with the second core network equipment to predict the second core network equipment that will enable the lower communication latency in connection with the communications to the user equipment.
